(19) United States
(12) Patent Application Publication
(10) Pub. No.: US 2008/0085055 A1
(43) Pub. Date: Apr. 10, 2008

(54) DIFFERENTIAL CLUSTER RANKING FOR IMAGE RECORD ACCESS

(76) Inventors: Cathleen D. Cerosaletti, Rochester, NY (US); Sharon Field, Rochester, NY (US); Alexander C. Loui, Penfield, NY (US)

Correspondence Address: David A. Novais;Patent Legal Staff, Eastman Kodak Company, 343 State Street, Rochester, NY, 14650-2201, US

(21) Appl. No.: 11/748,015

(22) Filed: May 14, 2007

Related U.S. Application Data
(60) Provisional application No. 60/828,493, filed on Oct. 6, 2006.

(51) Int. Cl. G06K 9/62

(52) U.S. Cl. 382/225

(57) ABSTRACT

In a method and system for providing access to a collection of records via a user interface, a plurality of different partitions of the collection are determined. Each partition is based on a different parameter. Each partition has two or more clusters having different values of the respective parameter. Weights are assigned to each of the clusters relative to all of the other clusters of all of the partitions. The clusters are rank ordered by weight to provide a single ranking. The user interface is equipped with controls that give user-selected direct access to each of the clusters of a leading portion of the ranking.

### CROSS REFERENCE TO RELATED APPLICATIONS

This is a 111A Application of Provisional Application Ser. No. 60/828,493, filed on Oct. 6, 2006.

Reference is made to commonly assigned, co-pending U.S. patent application Ser. No. ______, [Attorney Docket No. 92809], entitled: SUPPLYING DIGITAL IMAGES FROM A COLLECTION, filed May 9, 2007, in the names of Cathleen D. Cerosaletti and Alexander C. Loui.

### FIELD OF THE INVENTION

The invention relates to management and organization of digital image records and more particularly relates to methods and systems, in which image records can be accessed using ranked differential clusters.

### BACKGROUND OF THE INVENTION

With the growth of digital imaging, many users are having increasing trouble managing growing collections of image records, such as digital still images and video sequences. A wide variety of methods of organizing and accessing image records and other types of digital records have been proposed.

U.S. Patent Application Publication No. 2005/0289111, published Dec. 29, 2005, discloses a procedure, in which metadata found in or created from digital records is made available to a user using a search engine.

U.S. Patent Application Publication No. 2004/0075743, published Apr. 22, 2004, discloses filtering of a collection of images based on user preferences.

U.S. Patent Application Publication No. 2003/0048950, published Mar. 13, 2003 discloses automatic grouping and ranking of images based on image emphasis and appeal.

A general shortcoming of a great many of these approaches, is that user input is required. This presents a burden, particularly if ongoing efforts are required as image records are collected. A tendency is for persons to procrastinate until a particular output from the collection is needed and then to complete user input in a rush or proceed without the user input. Others of these approaches avoid the problem of user input by providing automatic categorization, without human intervention, based on preset criteria. This approach tends to provide organizational schemes that are standardized and may not be appropriate to the particular user.

It would thus be desirable to provide improved methods and systems, which organize image records of a collection without user input and are adaptive to a particular user.

### SUMMARY OF THE INVENTION

The invention is defined by the claims. The invention, in broader aspects, provides a method and system providing access to a collection of records via a user interface. In the method and system, a plurality of different partitions of the entire collection are determined. Each partition is based on a different parameter. Each partition has two or more clusters having different values of the respective parameter. Weights are assigned to each of the clusters relative to all of the other clusters of all of the partitions. The clusters are rank ordered by weight to provide a single ranking. The user interface is equipped with controls that give user-selected direct access to each of the clusters of a leading portion of the ranking.

It is an advantageous effect of the invention that improved methods and systems are provided, which organize image records of a collection with little or no user input and are adaptive to the particular user.

### BRIEF DESCRIPTION OF THE DRAWINGS

The above-mentioned and other features and objects of this invention and the manner of attaining them will become more apparent and the invention itself will be better understood by reference to the following description of an embodiment of the invention taken in conjunction with the accompanying figures wherein:

FIG. 1 is a diagram of an embodiment of the method.

FIG. 2 is a diagram of another embodiment of the method.

FIG. 3 is a semi-diagrammatical view of an embodiment of the system.

FIG. 4 is a semi-diagrammatical view of another embodiment of the system.

FIG. 5 is a semi-diagrammatical view of a display of the system of FIG. 3 or 4 showing a screen displaying clusters of a leading portion of the ranking.

FIG. 6 is a semi-diagrammatical view of a display of the system of FIG. 3 or 4 showing an alternative screen displaying clusters of a leading portion of the ranking.

FIG. 7 is a semi-diagrammatical view showing alternative drill-down menus provided by another embodiment of the system.

### DETAILED DESCRIPTION OF THE INVENTION

In the methods and systems, a collection of image records is repeatedly clustered by heterogeneous partitionings into a plurality of different partitions. The clusters are compiled into a single group to provide a plurality of differential clusters, that is, clusters from multiple different partitionings. Weights are assigned to the clusters of the plurality, that is, across the different partitions, and clusters are rank ordered by weights to provide a single ranking. A user interface is then equipped with controls giving user-selected direct access to each of the clusters of at least a leading portion of the ranking.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular and/or plural in referring to the “method” or “methods” and the like is not limiting.

The term “image record” is used here to refer to a digital still image, video sequence, or multimedia record. An image record is inclusive of one or more digital images and can also include metadata, such as sounds or textual annotations. A particular image record can be a single digital file or multiple, associated digital files. Metadata can be stored in the same image file as the associated digital image or can be stored separately. Examples of image records include multiple spectrum images, scannerless range images, digital album pages, and multimedia video presentations. With a video sequence, the sequence of images is a single image record. Each of the images in a sequence can alternatively or additionally be treated as a separate image record. Discussion herein is generally directed to image records that are captured using a digital camera. Image records can also be captured using other capture devices and by using photographic film or other means and then digitizing. As discussed herein, image records are stored digitally along with associated information.

The term “subject” is used in a photographic sense to refer to one or more persons or other items in a captured scene that as a result of perspective are distinguishable from the remainder of the scene, referred to as the background. Perspective is inclusive of such factors as: linear perspective (convergence to a vanishing point), overlap, depth of field, lighting and color cues, and, in appropriate cases, motion perspective and motion parallax.

In the following description, some features are described as “software” or “software programs”. Those skilled in the art will recognize that the equivalent of such software can also be readily constructed in hardware. Because image manipulation algorithms and systems are well known, the present description emphasizes algorithms and features forming part of, or cooperating more directly with, the method. General features of the types of computerized systems discussed herein are well known, and the present description is generally limited to those aspects directly related to the method of the invention. Other aspects of such algorithms and apparatus, and hardware and/or software for producing and otherwise processing the image signals involved therewith, not specifically shown or described herein may be selected from such systems, algorithms, components, and elements known in the art. Given the description as set forth herein, all additional software/hardware implementation is conventional and within the ordinary skill in the art.

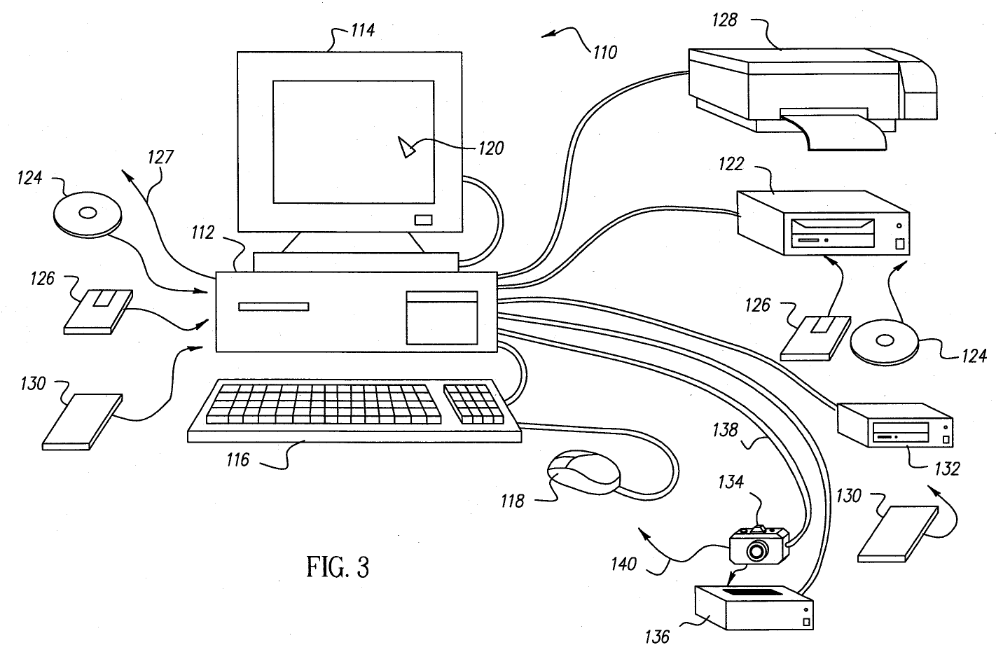

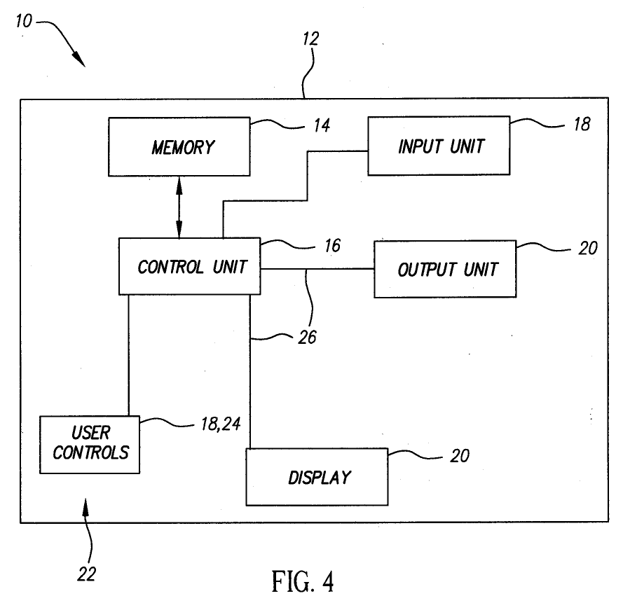

FIG. 4 illustrates an embodiment of the system. The system 10 has a housing 12, memory 14 having a collection of image records, a control unit 16, input units 18 (including user controls) and output units 20 (including a display) connected to the control unit 16. The system 10 has a user interface 22 that includes user controls 24 and can include some or all of the input and output units 18,20. Components are connected by signal paths 26 and, in this embodiment, the system components and signal paths are located within the housing 12 as illustrated. In other embodiments, one or more components and signal paths can be located in whole or in part outside of the housing. The present invention can be implemented in computer hardware and computerized equipment. For example, the method can be performed using a system including one or more digital cameras or other capture devices and/or one or more personal computers. FIG. 3 illustrates another embodiment, in which the system includes a general purpose computer and various peripherals. The present invention is not limited to the computer system 110 shown, but may be used with any electronic processing system such as found in digital cameras, cellular camera phones and other mobile devices, home computers, kiosks, retail or wholesale photofinishing, or any other system for the processing of digital images. Different components of the system can be completely separate or can share one or more hardware and/or software features with other components.

The control unit operates the other components of the system utilizing stored software and data based upon signals from the input units. The control unit can include, but is not limited to, a programmable digital computer, a programmable microprocessor, a programmable logic processor, a series of electronic circuits, a series of electronic circuits reduced to the form of an integrated circuit, or a series of discrete components.

In addition to functions necessary to operate the system, the control unit manipulates image records according to software programs stored in memory either automatically or with user intervention. For example, a digital still image can be processed by a digital signal processor of the control unit to provide interpolation and edge enhancement. Similarly, an image record can be transformed to accommodate different output capabilities, such as gray scale, color gamut, and white point of a display. The displayed image can be cropped, reduced in resolution and/or contrast levels, or some other part of the information in the stored digital image can be omitted. Modifications related to file transfer, can include operations such as, JPEG compression and file formatting. Other enhancements can also be provided. The image modifications can also include the addition or modification of metadata, that is, image record associated non-image information.

“Memory” refers to one or more suitably sized logical units of physical memory provided in semiconductor memory or magnetic memory, or the like. Memory of the system can store a computer program product having a program stored in a computer readable storage medium. Memory can include conventional memory devices including solid state, magnetic, optical or other data storage devices and can be fixed within system or can be removable. For example, memory can be an internal memory, such as, such as SDRAM or Flash EPROM memory, or alternately a removable memory, or a combination of both. Removable memory can be of any type, such as a Secure Digital (SD) type card inserted into a socket and connected to the control unit via a memory interface. Other types of storage that are utilized include without limitation PC-Cards and embedded and/or removable hard drives. In the embodiment of FIG. 3, system is shown having a hard drive, a disk drive for a removable disk such as an optical, magnetic or other disk memory (not shown) and a memory card slot that holds a removable memory, such as a removable memory card and has a removable memory interface for communicating with removable memory. Data including but not limited to control programs, digital images and other image records, and metadata can also be stored in a remote memory system such as a personal computer, computer network or other digital system.

The input units can comprise any form of transducer or other device capable of receiving an input from a user and converting this input into a form that can be used by the control unit. Similarly, the output units can comprise any form of device capable of delivering an output in human perceptible form or in computer readable form as a signal or as part of a computer program product. Input and output units can be local or remote. A wired or wireless communications system that incorporates hardware and software of one or more input and output units can be included in the system.

The input units of the user interface can take a variety of forms. For example, the user interface can comprise a touch screen input, a touch pad input, a 4-way switch, a 6-way switch, an 8-way switch, a stylus system, a trackball system, a joystick system, a voice recognition system, a gesture recognition system, a keyboard, a remote control, or other such devices. The user interface can include an optional remote input, including, for example, a remote keyboard and a remote mouse.

Input devices can include one or more sensors, which can include light sensors, biometric sensors, and other sensors known in the art that can be used to detect conditions in the environment of system and to convert this information into a form that can be used by control unit of the system. Light sensors can include one or more ordinary cameras and/or multispectral sensors. Sensors can also include audio sensors that are adapted to capture sounds. Sensors can also include biometric or other sensors for measuring involuntary physical and mental reactions such sensors including but not limited to voice inflection, body movement, eye movement, pupil dilation, body temperature, and p4000 wave sensors.

Output units can also vary widely. In a particular embodiment, the system includes a display, a printer, and a memory writer as output units. The printer can record images on receiver medium using a variety of known technologies including, but not limited to, conventional four color offset separation printing or other contact printing, silk screening, dry electrophotography such as is used in the NexPress 2500 printer sold by Eastman Kodak Company, Rochester, N.Y., USA, thermal printing technology, drop on demand ink jet technology, and continuous inkjet technology. For the purpose of the following discussions, the printer will be described as being of a type that generates color images on a paper receiver; however, it will be appreciated that this is not necessary and that the claimed methods and apparatuses herein can be practiced with a printer that prints monotone images such as black and white, grayscale or sepia toned images and with a printer that prints on other types of receivers.

A communication system can comprise for example, one or more optical, radio frequency or other transducer circuits or other systems that convert image and other data into a form that can be conveyed to a remote device such as remote memory system or remote display device using an optical signal, radio frequency signal or other form of signal. Communication system can also be used to receive a digital image and other data from a host or server computer or network (not shown), a remote memory system or a remote input. Communication system provides control unit with information and instructions from signals received thereby. Typically, communication system will be adapted to communicate with the remote memory system by way of a communication network such as a conventional telecommunication or data transfer network such as the Internet, a cellular, peer-to-peer, or other form of mobile telecommunication network, a local communication network such as wired or wireless local area network or any other conventional wired or wireless data transfer system.

A source of image records can be provided in the system. The source of image records can include any form of electronic or other circuit or system that can supply the appropriate digital data to the control unit. The source of image records can be a camera or other capture device that can capture content data for use in image records and/or can obtain image records that have been prepared by or using other devices. For example, a source of image records can comprise a set of docking stations, intermittently linked external digital capture and/or display devices, a connection to a wired telecommunication system, a cellular phone, and/or a wireless broadband transceiver providing wireless connection to a wireless telecommunication network. As other examples, a cable link provides a connection to a cable communication network and a dish satellite system provides a connection to a satellite communication system. An Internet link provides a communication connection to a remote memory in a remote server. A disk player/writer provides access to content recorded on an optical disk.

Referring to FIG. 3, the computer system 110 includes a control unit 112 for receiving and processing software programs and for performing other processing functions. A display 114 is electrically connected to the control unit 112 for displaying user-related information associated with the software, e.g., by means of a graphical user interface. A keyboard 116 is also connected to the control unit 112 for permitting a user to input information to the software. As an alternative to using the keyboard 116 for input, a mouse 118 may be used for moving a selector 120 on the display 114 and for selecting an item on which the selector 120 overlays, as is well known in the art.

Removable memory, in any form, can be included and is illustrated as a compact disk-read only memory (CD-ROM) 124, which can include software programs, is inserted into the microprocessor based unit for providing a means of inputting the software programs and other information to the microprocessor based unit 112. Multiple types of removable memory can be provided (illustrated here by a floppy disk 126) and data can be written to any suitable type of removable memory. Memory can be external and accessible using a wired or wireless connection, either directly or via a local or large area network, such as the Internet. Still further, the control unit 112 may be programmed, as is well known in the art, for storing the software program internally. A printer or other output device 128 can also be connected to the control unit 112 for printing hardcopy output from the computer system 110. The control unit 112 can have a network connection 127, such as a telephone line or wireless link, to an external network, such as a local area network or the Internet.

Images can be obtained from a variety of sources, such as a digital camera or a scanner. Images can also be input directly from a digital camera 134 via a camera docking port 136 connected to the control unit 112, directly from the digital camera 134 via a cable connection 138 to the control unit 112, via a wireless connection 140 to the control unit 112, or from memory.

The output device 128 provides a final image(s) that has been subject to transformations. The output device can be a printer or other output device that provides a paper or other hard copy final image. The output device can provide a soft copy final image. Such soft copy output devices include displays and projectors. The output device can also be an output device that provides the final image(s) as a digital file. The output device can also include combinations of output, such as a printed image and a digital file on a memory unit, such as a CD or DVD which can be used in conjunction with any variety of home and portable viewing device, such as a personal media player or flat screen television.

The control unit 112 provides means for processing the digital images to produce pleasing looking images on the intended output device or media. The control unit 112 can be used to process digital images to make adjustments for overall brightness, tone scale, image structure, etc. of digital images in a manner such that a pleasing looking image is produced by an image output device. Those skilled in the art will recognize that the present invention is not limited to just these mentioned image processing functions.

Referring to FIGS. 3-4, in particular embodiments, the system is or includes a camera that has a body, which provides structural support and protection for other components. An electronic image capture unit (not shown), which is mounted in the body, has a taking lens and an electronic array image sensor aligned with the taking lens. In the capture unit, captured electronic images from the image sensor are amplified, converted from analog to digital, and processed to provide one or more image records.

The camera has a user interface, which provides outputs to the photographer and receives photographer inputs. The user interface includes one or more user input features (labeled “user inputs” in FIG. 4) and an image display. User input features can include a shutter release, a “zoom in/out” control that controls the zooming of the lens units, and other user controls. User input controls can be provided in the form of a combination of buttons, rocker switches, joysticks, rotary dials, touch screens, microphones and processors employing voice recognition responsive to user initiated auditory commands, microphones and processors employing voice recognition responsive to user initiated auditory commands, and the like. The user interface can include user reaction tracking features, such as an image sensor, a galvanic response sensor, and the above-mentioned microphone. These controls can store unanalyzed information for later analysis or a module capable of analyzing user responses and generating appropriate metadata can be included in the user interface. U.S. Patent Publication No. 2003/0128389 A1, filed by Matraszek et al., discusses the generation of metadata from user reaction tracking.

The user interface can include one or more information displays to present camera information to the photographer, such as exposure level, exposures remaining, battery state, flash state, and the like. The image display can instead or additionally also be used to display non-image information, such as camera settings. For example, a graphical user interface (GUI) can be provided, including menus presenting option selections and review modes for examining captured images. Both the image display and a digital viewfinder display (not illustrated) can provide the same functions and one or the other can be eliminated. The camera can include a speaker and/or microphone (not shown), to receive audio inputs and provide audio outputs.

The camera assesses ambient lighting and/or other conditions and determines scene parameters, such as shutter speeds and diaphragm settings using the imager and/or other sensors. The image display produces a light image (also referred to here as a “display image”) that is viewed by the user.

The control unit controls or adjusts the exposure regulating elements and other camera components, facilitates transfer of images and other signals, and performs processing related to the images. The control unit includes support features, such as a system controller, timing generator, analog signal processor, A/D converter, digital signal processor, and dedicated memory. As with the control units earlier discussed, the control unit can be provided by a single physical device or by a larger number of separate components. For example, the control unit can take the form of an appropriately configured microcomputer, such as an embedded microprocessor having RAM for data manipulation and general program execution. The timing generator supplies control signals for all electronic components in timing relationship. The components of the user interface are connected to the control unit and function by means of executed software programs. The control unit also operates the other components, including drivers and memories.

The camera can include other components to provide information supplemental to captured image information. Examples of such components are an orientation sensor, a real time clock, a global positioning system receiver, and a keypad or other entry device for entry of user captions or other information.

The method and apparatus herein can include features provided by software and/or hardware components that utilize various data detection and reduction techniques, such as face detection, skin detection, people detection, other object detection, for interpreting the scene depicted on an image, for example, a birthday cake for birthday party pictures, or characterizing the image, such as in the case of medical images capturing specific body parts.

It will be understood that the circuits shown and described can be modified in a variety of ways well known to those of skill in the art. It will also be understood that the various features described here in terms of physical circuits can be alternatively provided as firmware or software functions or a combination of the two. Likewise, components illustrated as separate units herein may be conveniently combined or shared. Multiple components can be provided in distributed locations.

Image records may be subject to automated pattern classification. It will be understood that the invention is not limited in relation to specific technologies used for these purposes, except as specifically indicated. For example, pattern classification can be provided by any of the following, individually or in combination: rule based systems, semantic knowledge network approaches, frame-based knowledge systems, neural networks, fuzzy-logic based systems, genetic algorithm mechanisms, and heuristics-based systems.

A digital image includes one or more digital image channels or color components. Each digital image channel is a two-dimensional array of pixels. Each pixel value relates to the amount of light received by the capture device corresponding to the physical region of the respective pixel. For color imaging applications, a digital image will often consist of red, green, and blue digital image channels. Motion imaging applications can be thought of as a sequence of digital images. Those skilled in the art will recognize that the present invention can be applied to, but is not limited to, a digital image channel for any of the herein-mentioned applications. Although a digital image channel is described as a two dimensional array of pixel values arranged by rows and columns, those skilled in the art will recognize that the present invention can be applied to non-rectilinear arrays with equal effect.

It should also be noted that the present invention can be implemented in a combination of software and/or hardware and is not limited to devices, which are physically connected and/or located within the same physical location. One or more of the devices illustrated in FIG. 3 can be located remotely and can be connected via a network. One or more of the devices can be connected wirelessly, such as by a radio-frequency link, either directly or via a network.

The present invention may be employed in a variety of user contexts and environments. Exemplary contexts and environments include, without limitation, wholesale imaging services, retail imaging services, use on desktop home and business computers, use on kiosks, use on mobile devices, and use as a service offered via a network, such as the Internet or a cellular communication network.

Portable display devices, such as DVD players, personal digital assistants (PDA's), cameras, and cell phones can have features necessary to practice the invention. Other features are well known to those of skill in the art. In the following, cameras are sometimes referred to as still cameras and video cameras. It will be understood that the respective terms are inclusive of both dedicated still and video cameras and of combination still/video cameras, as used for the respective still or video capture function. It will also be understood that the camera can include any of a wide variety of features not discussed in detail herein, such as, detachable and interchangeable lenses and multiple capture units. The camera can be portable or fixed in position and can provide one or more other functions related or unrelated to imaging. For example, the camera can be a cell phone camera or can provide communication functions in some other manner. Likewise, the system can take the form of a portable computer, an editing studio, a kiosk, or other non-portable apparatus.

In each context, the invention may stand alone or may be a component of a larger system solution. Furthermore, human interfaces, e.g., the scanning or input, the digital processing, the display to a user, the input of user requests or processing instructions (if needed), the output, can each be on the same or different devices and physical locations, and communication between the devices and locations can be via public or private network connections, or media based communication. Where consistent with the disclosure of the present invention, the method of the invention can be fully automatic, may have user input (be fully or partially manual), may have user or operator review to accept or reject the result, or may be assisted by metadata (metadata that may be user supplied, supplied by a measuring device (e.g. in a camera), or determined by an algorithm). Moreover, the algorithm(s) may interface with a variety of workflow user interface schemes.

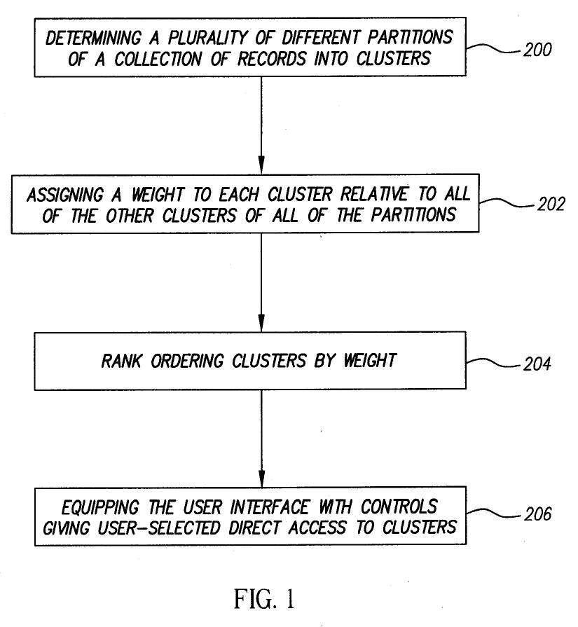

Referring to FIGS. 1-2 and 5-7, the invention, provides a method for providing access to a collection of records via a user interface. The records can be of any type, but the method is particularly advantageous for use with image records. For convenience, the method is generally discussed herein relative to the latter embodiment. It will be understood that like considerations apply to other embodiments. The method can be performed with user intervention at one or more stages, but is particularly advantageous for use without human intervention.

The image records are first collected in any manner. The size of the collection of image records is not critical, but larger collections require longer processing times or increased computational resources. The collection can be defined physically or logically within memory of the system. For example, a database can physically include image records and other types of records, but the method can be configured to only consider a logical collection consisting of the image records and excluding other types of records.

A plurality of different partitions of the collection are determined (200). Each partition is based on a different parameter. Each partition divides the entire collection into two or more clusters having different values of the respective parameter. Typically, each cluster has a range of values and particular values are exclusive to the respective cluster. Weights are then assigned (202) to each of the clusters. The weights are relative to all of the other clusters of all of the partitions. The clusters are rank ordered (204) by respective weights to provide a single ranking. The user interface is then equipped (206) with controls identifying and giving user-selected direct access to each of the clusters of a leading portion of the ranking.

The partitioning is performed logically. Computational demands are a function of the particular parameters used. Each partition divides the collection into two or more clusters based on respective values of the partition parameter. Within a particular partition, a cluster has a unique set of image records. The images records may or may not be uniquely present in only one cluster. For example, a partition can uniquely assign image records to one of the clusters: no people, one person, two persons, and more than two persons. These clusters all have a unique set of image records. Alternatively, a partition can assign image records to one of the clusters: no people, one or more persons, two or more persons, three or more persons. In this case, the image records of the clusters, “two or more persons” and “three or more persons”, are included in the cluster, “one or more persons”, and the image records of the cluster, “three or more persons”, are included in the cluster, “two or more persons”.

The system including components that can be provided by appropriately programmed computer hardware. A memory holds a collection of image records. A user interface has one or more input controls and one or more output units. A control unit is operatively connected to the memory and the user interface. The control unit provides functional components that operate in accordance with the method. Further details of the system will be understood from the discussion of the method.

In the method, a partitioning can be attempted that does not divide the collection into two or more clusters, but instead provides only a single cluster, which may be in the form of uniform distribution. In that case, that particular partition is only marginally useful to the method and can be treated as surplusage to the other partitions. The single cluster partition can be deleted or allowed to remain in the ranking.

The clusters of each partition are generated using the particular parameter. This can be a simple or complex process. In a simple example, a partition can divide image records between a cluster having associated metadata providing annotations or lacking such metadata. A more complex example is clusters generated using one of the event clustering algorithms discussed below.

The parameters each have a range of values and preferably relate to general features, such that each image record is capable of having a value of each of the parameters. Parameters can be limited to a binary measure. For example, a parameter can be the presence or absence of a particular characteristic or set of characteristics in a particular image record. Similarly, a parameter can be based on whether an image record at least meets or does not meet a particular resolution threshold. Parameters can also have non-binary values. For example, a number of points can be assigned based on the number of faces detected in an image record. Parameters can be non-comparative, that is, limited to aspects of a particular image record, or can be relative to all of the image records in the collection or a particular subset of those records. The number of faces detected in an image record in non-comparative. The commonest number of faces detected in image records of the collection, second commonest, and so on, is an example of a relative measure of image records.

The characteristics on which parameters can be based include saliency features of the image records and metadata associated with the image records. The saliency features are ascertained (208) from the images in the image records. The nature and use of saliency features are discussed in U.S. Pat. No. 6,671,405, to Savakis, et al., entitled “METHOD FOR AUTOMATIC ASSESSMENT OF EMPHASIS AND APPEAL IN CONSUMER IMAGES”, which is hereby incorporated herein by reference. The metadata is located in or associated with the image records is read. The saliency features include structural saliency features and semantic saliency features. The saliency features and metadata can relate to an entire image or group of images or can relate to part of an image or correspond parts of a series of images. For example, the saliency feature can be resolution of the main subject, which differs due to depth of field between a foreground subject and background of an image. After saliency features are determined, those features can be saved in the same manner as other metadata. For convenience, the term “saliency feature” and like terms are inclusive of saved saliency feature information and the term “metadata” is exclusive of saliency feature information.

Structural saliency features are physical characteristics of the images in the image records and include low-level early vision features and geometric features. The low-level early vision features include color, brightness, and texture. The geometric features include location, such as centrality; spatial relationship, such as borderness, adjacency, surroundedness, and occlusion; size; shape; and symmetry. Other examples of structural saliency features include: image sharpness, image noise, contrast, presence/absence of dark background, scene balance, skin tone color, saturation, clipping, aliasing, and compression state. Example parameters based on such features are a numerical measure of resolution and a binary measure of the presence or absence of very low contrast in an image. Structural saliency features are derived from an analysis of the image data of an image record. Structural saliency features are related to limitations in the capture of an original scene and any subsequent changes in the captured information, and are unrelated to content.

Semantic saliency features are higher level features in the forms of key subject matters of an image. Examples of image content data include: presence/absence of people, number of people, gender of people, age of people, redeye, eye blink, smile expression, head size, translation problem, subject centrality, scene location, scenery type, and scene uniqueness. (“Translation problem” is defined as an incomplete representation of the main object in a scene, such as a face, or a body of the person.) For example, sunsets can be determined by an analysis of overall image color, as in U.S. Published Patent Application No. US20050147298 A1, filed by A. Gallagher et al., and portraits can be determined by face detection software, such as U.S. Published Patent Application US20040179719 A1, filed by S. Chen. The analysis of “image content”, as the term is used here, is inclusive of image composition.

Semantic saliency features can be divided based on relative position in the foreground or background of an image. An example of a foreground semantic saliency feature is people. Examples, of background semantic saliency features are skin, face, sky, grass, and other green vegetation. Examples of specific semantic saliency features are: presence or absence of people, number of people, gender of people, age of people, presence or absence of sports equipment, presence or absence of buildings, presence or absence of animals, redeye, eye blink, emotional expression, head size, translation problem, subject centrality, scenery type, presence or absence of buildings. Examples of structural saliency features include: image sharpness, image noise, contrast, presence or absence of dark background, scene balance, skin tone color, saturation, clipping, aliasing, and compression state.

Metadata is information associated with an image record that is additional to the data necessary to form the image or images. Metadata can be part of the image record(s) to which it relates or can be separate from that image record(s). A great many types of metadata are known. Particularly useful types of metadata include: capture metadata relating to conditions at the time of image capture, usage metadata relating to usage of a particular image or group of images following capture, and user preferences. Like images, metadata can be edited and later-added metadata can take the place of missing metadata or supplement or replace earlier recorded metadata.

Capture metadata is data available at the time of capture that defines capture conditions, such as exposure, location, date-time, status of camera functions, and the like. Examples of capture metadata include: spatiotemporal information, such as timestamps and geolocation information like GPS data; camera settings, such as focal length, focus distance, flash usage, shutter speed, lens aperture, exposure time, digital/optical zoom status, and camera mode (such as portrait mode or sports/action mode); image size; identification of the photographer; textual or verbal annotations provided at capture; detected subject(s) distance; flash fired state.

Capture metadata relates to both set up and capture of an image record and can also relate to on-camera review of the image record. Capture metadata can be derived from user inputs to a camera or other capture device. Each user input provides a signal to the control unit of the camera, which defines an operational setting. For example with a particular camera, the user moves an on-off switch to power on the camera. This action places the camera in a default state with a predefined priority mode, flash status, zoom position, and the like. Similarly, when the user provides a partial shutter button depression, autoexposure and autofocus engage, a sequence of viewfinder images begins to be captured and automatic flash set-up occurs. The user enters inputs using a plurality of camera user controls that are operatively connected to a capture unit via a control unit. The user controls can also include user viewfinder-display controls that operate a viewfinder-display unit for on-camera review of an image or images following capture. Examples of user inputs include: partial shutter button depression, full shutter button depression, focal length selection, camera display actuation, selection of editing parameters, user classification of an image record, and camera display deactuation. The viewfinder-display controls can include one or more user controls for manual user classification of images, for example, a “share” or “favorite” button. Metadata based on user inputs can include inputs received during composition, capture, and, optionally, during viewing of an image record. If several images are taken of the same scene or with slight shifts in scene (for example as determined by a subject tracking autofocus system and the recorded time/date of each image), then information data related to all of the images can be used in deriving the capture metadata of each of the images.

Another example of capture metadata is temporal values calculated from temporal relationships between two or more of the camera inputs. Temporal relationships can be elapsed times between two inputs or events occurring within a particular span of time. Examples are inputs defining one or more of: image composition time, S1-S2 stroke time, on-camera editing time, on-camera viewing time, and elapsed time at a particular location (determined by a global positioning system receiver in the camera or the like) with the camera in a power on state. Temporal relationships can be selected so as to all exemplify additional effort on the part of the user to capture a particular image or sequence of images. Geographic relationships between two or more inputs can yield information data in the same manner as temporal relationships as can combinations of different kinds of relationships, such as inputs within a particular time span and geographic range.

Other examples of capture related image data include information derived from textual or vocal annotation that is retained with the image record, location information, current date-time, photographer identity. Such data can be entered by the user or automatically. Annotations can be provided individually by a user or can be generated from information content or preset information. For example, a camera can automatically generate the caption “Home” at a selected geographic location or a user can add the same caption. Suitable hardware and software for determining location information, such as Global Positioning System units are well known to those of skill in the art. Photographer identity can be determined by such means as: use of an identifying transponder, such as a radio frequency identification device, user entry of identification data, voice recognition, or biometric identification, such as user's facial recognition or fingerprint matching. Combinations of such metadata and other parameters can be used to provide image data. For example, date-time information can be used in combination with prerecorded identifications of holidays, birthdays, or the like.

Image usage data is data relating to usage of a particular image record following capture. This data can reflect the usage itself or steps preparatory to that usage, for example, editing time prior to storage or printing of a revised image. Examples of image usage data include: editing time, viewing time, number of reviews, number of hard copies made, number of soft copies made, number of e-mails including a copy or link to the respective image record, number of recipients, usage in an album, usage in a website, usage as a screensaver, renaming, annotation, archival state, and other fulfillment usage. Examples of utilization on which the image usage data is based include: copying, storage, organizing, labeling, aggregation with other information, image processing, non-image processing computations, hard copy output, soft copy display, and non-image output. Equipment and techniques suitable for image record utilization are well known to those of skill in the art. For example, a database unit that is part of a personal computer can provide output via a display or a printer. In addition to direct usage information, usage data can include data directly comparable to the temporal values earlier discussed. For example, the time viewing and editing specific image records can be considered.

Metadata can be in the form of a value index, such as those disclosed or discussed in U.S. patent application Ser. No. 11/403,686, filed 13 Apr. 2006, by Elena A. Fedorovskaya, et al., entitled “VALUE INDEX FROM INCOMPLETE DATA” and in U.S. patent application Ser. No. 11/403,583, filed Apr. 13, 2006, by Joseph A. Manico, et al., entitled “CAMERA USER INPUT BASED IMAGE VALUE INDEX”. Metadata can also be based on or derived from any of the information used in creating the value indexes in those patent applications and any combinations thereof.

Metadata can include user reaction tracking information, either in the form of user responses or analyzed results. U.S. Patent Publication No. 2003/0128389 A1, filed by Matraszek et al., discusses the generation of metadata from user reaction tracking. User reaction data is based upon observation of the reactions of the user to a respective image record. U.S. Patent Publication No. 2003/0128389 A1, to Matraszek et al., which is hereby incorporated herein by reference, discloses techniques for detecting user reactions to images. (For purposes herein, “user reactions” are exclusive of image usage and of the above-discussed inputs used for camera control.) Examples of user reactions include: vocalizations during viewing, facial expression during viewing, physiological responses, gaze information, and neurophysiological responses. User reactions can be automatically monitored via a biometric device such as a GSR (galvanic skin response) or heart rate monitor. These devices have become low cost and readily available and incorporated into image capture and display device as described in Matraszek et al. requesting user information and predetermining said parameters using said user information.

Metadata can be in the form of information provided by a user, either responsive to a request by the system or as initiated by the user. It is convenient, if such information is received prior to the other steps of the method, for example, when a database of image records is being set up.

The saliency features and metadata can be used individually and in combination and can be used to calculate derived features that are then used in the parameters either directly or in further combinations. (The saliency features and derived features can also first be saved as metadata.) Image data in each category can also include data derived from other image data. Examples of derived information include: compatibility of image data with a pre-established user profile, and a difference or similarity of image content to one or more reference images determined to have a high or low value index.

The derived features can be based on saliency features and/or metadata of one or more image records. The analysis can be simple or complex depending upon particular needs and time constraints. For example, date/time information can be compared to a predetermined set of criteria, such as holidays or birthdays to determine if an image record meets those criteria. Similarly, detected people and objects can be identified and metadata can be recorded indicating the presence or absence of a particular person or object. Images can also be analyzed for image quality and composition. For example, the size of main subject and the goodness of composition can be determined by main subject mapping and comparison to a set of predetermined composition rules. A example of a main subject detector that can be used in such an analysis is disclosed in U.S. Pat. No. 6,282,317 to Luo et al. Main subject can also be determined directly from metadata that has camera rangefinder data. The analysis can be an assessment of images can be performed with a reasoning engine, such as a Bayesian network, which accepts as input a combination of simpler analysis results along with some combination of saliency features and metadata.

Parameters can be based on determined events and sub-events in the collection of image records. For example, event clustering can be performed on the image records based upon date-time information, location information, and/or image content. For example, clustering as disclosed in U.S. Published Patent Application No. US20050105775 A1 or U.S. Pat. No. 6,993,180 can be used. Classifying by events and subevents can be provided using one of a variety of known event clustering techniques. U.S. Pat. No. 6,606,411, to A. Loui and E. Pavie, entitled “A method for automatically classifying images into events”, issued Aug. 12, 2003 and U.S. Pat. No. 6,351,556, to A. Loui, and E. Pavie, entitled “A method for automatically comparing content of images for classification into events”, issued Feb. 26, 2002, disclose algorithms for clustering image content by events and subevents. Other methods of automatically grouping images by event are disclosed in U.S. Patent Application Publication No. US2006/0204520 A1, published May 18, 2006, by B. Kraus and A. Loui, entitled “Multi-tiered image clustering by event”, and U.S. Patent Application Publication No. US2006/0126944 A1, published Jun. 15, 2006, by A. Loui and B. Kraus, entitled “Variance-based event clustering”. Another method of automatically organizing images into events is disclosed in U.S. Pat. No. 6,915,011, to A. Loui, M. Jeanson, and Z. Sun, entitled “Event clustering of images using foreground and background segmentation”, issued Jul. 5, 2005. Another method is U.S. patent application Ser. No. 11/197,243, filed 4 Aug. 2005, by Bryan D. Kraus, et al., entitled “Multi-tiered image clustering by event”. The selection of a particular spatio-temporal classification technique can be based on the advantages of the particular technique or on convenience of as determined heuristically for a collection of images. Results of the event clustering can be used as capture metadata.

A convenient set of parameters are: number of people, presence or absence of buildings, flash used or flash not used, presence or absence of date metadata matching one of a predetermined set of holidays, presence or absence of date metadata matching one of a predetermined set of birthdays, sky present or absent and focus at infinity, and sports/fast action mode selected or deselected.

After the partitions are all determined, weights are assigned to each of the clusters of all of the partitions and all of the clusters of all or the partitions are rank ordered relative to each other. The assignment of weights requires an interest metric that is common to the clusters of the different partitions and has a range of values that can be predicted to be proportional to the user's interest in a particular cluster. A convenient interest metric is the number of image records in a respective cluster or a function of that number. Another example of an interest metric is usage of the image records in the different clusters or a function of that usage. The various characteristics and combinations and derivations of characteristics discussed above in relation to use as parameters for partitioning can be used in the evaluation of an interest metric, to the extent that the particular characteristics and derivations are common to the clusters of the different partitions and are likely to reflect user interest. The rank ordering is a logical procedure and not particularly computationally intensive depending upon how weights are assigned. This is convenient for reranking when additional image records are added to the collection.

The ranking is a deliberate comparison of different clusters from unrelated partitions, what can be referred to as “differential clusters”. This is like the proverbial comparison of apples and oranges; however, it has been determined that the highest ranked of the resulting clusters are most likely to match user interests. Where a user is interested in a particular cluster, the user is less likely to have an interest in other cluster(s) of that partition. This is particularly true for binary partitions, that is, partitions with only two clusters. For this reason, weights are assigned so as to exclude a plurality of predetermined low interest clusters from the leading portion. It is preferred that the assigning of weights limit each binary partition to only one cluster in the leading portion of the ranking. This can be readily accomplished by presetting an arbitrary low weight for one of the clusters in the binary partition, relative to all of the other clusters of all of the partitions, rather than assigning a weight based on the interest metric used for the other clusters. For example, in a binary partition relating to animal images, a cluster with the feature animal present can be assigned a value based on an interest metric, such as the number of images, and the cluster with the feature animal absent can be assigned a value of zero. This moves the cluster “animal absent” to the bottom of the ranking, on the presumption that a user is unlikely to have much interest in an “animal absent” cluster. It is expected that some clusters are very unlikely to be of value to a user, such as, a cluster of very low resolution images or a cluster of very underexposed or overexposed images. Low relative weights can be preset for these low value clusters. Where user interest is less predictable, all of the clusters in a partition can be assigned weights based on the interest metric.

The rank ordering provides, in effect, a list of clusters in order of relative values of the interest metric in the respective clusters. A list is limited to a leading portion of the ranking and is provided to the user in the user interface in the form of controls giving user-selected direct access to each of those clusters. The entire list can be provided to the user on the user interface, either in stages (leading portion then remaining portion) or immediately, rather than just a leading portion; but this approach is not preferred, since many of the clusters are expected to be of little or no value to the user.

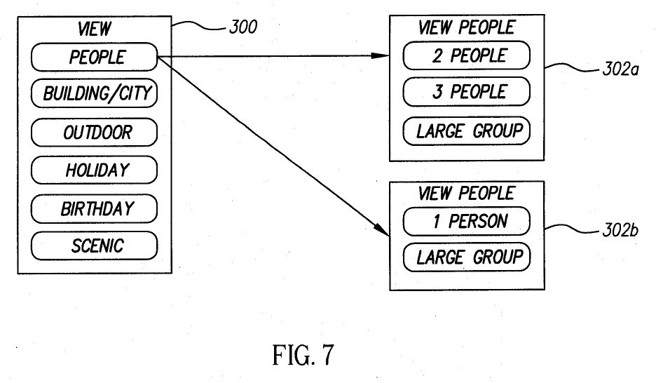

The system next equips the user interface with an active list, that is, user controls identifying and giving user-selected direct access to each of the clusters of the list. The list with user controls can be provided in any form. For example, as shown in FIG. 7, a drop-down or other menu can be provided on the user interface. The menu can indicate the order of the clusters, for example, by listing identifications of the clusters in rank order. The menu can be actuated by use of a mouse or other pointing-designation device or by reprogramming physical buttons or other hardware controls as required. In FIG. 7, an initial drop down menu 300 two alternative drill down menus 302a and 302b are shown. The alternative menus 302a and 302b represent the effect of different user preferences.

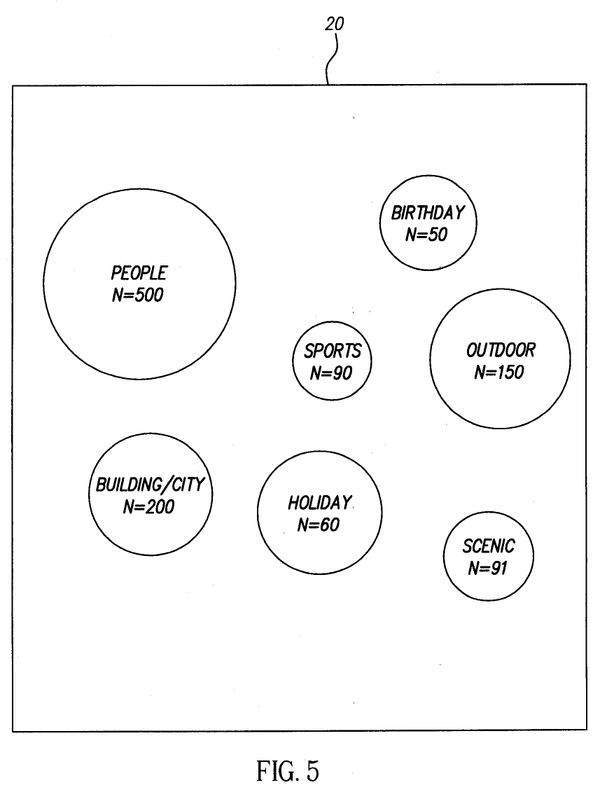

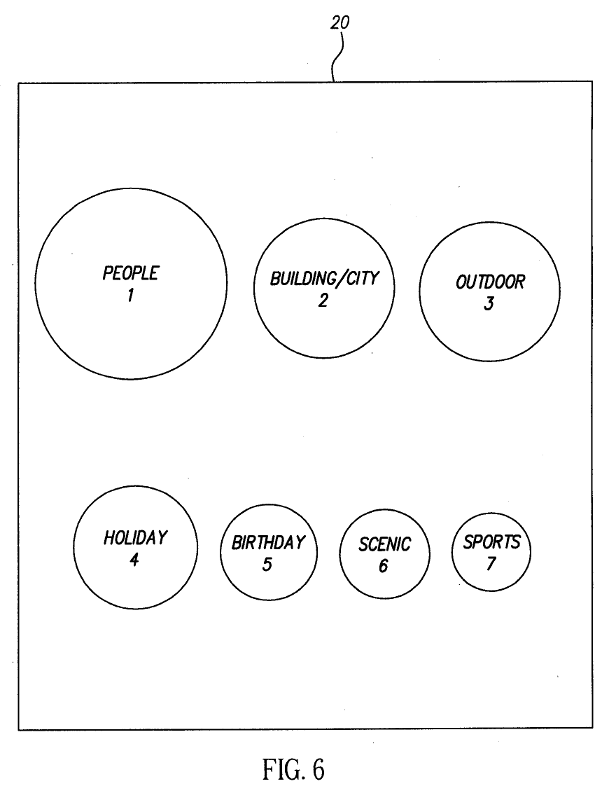

Referring to FIG. 6, the menu can also indicate the relative weights of the clusters, for example, by providing soft menu buttons in sizes proportional to the relative weights. Referring to FIG. 5, the menus can also group by similarities of clusters. The identifications can be by text or other indicia and can be predetermined based on expected or possible clusters in the partitions to be determined. When the user selects a particular cluster, that cluster can be presented to the user on a display as a list or thumbnails or full scale images or the like. Alternatively, a particular function can be performed on the image records of the cluster, for example, sending copies to persons on a mail list. Appropriate software to provide these features in a wide variety of user interfaces is well known to those of skill in the art.

For example, a user interface can be provided by software that is segmented into a navigation file, screen sub-images, and software applets. The application software is divided into a large number of Java and C++ applets that perform individual functions. Displayed screens of the user interface are likewise divided into a large number of small visual segments. The navigation file links the small visual segments and the applets together to create the user interface and navigate the consumer through a variety of sequences.

It is highly preferred that the system provides the active list without user intervention other than optional input of user preferences prior to the partitioning of the collection into clusters, since the advantage so provided is a measure of organization of image records without effort on the part of the user. In that case, the user actuates the user interface on the system having the collection and the active list appears and is ready for use.

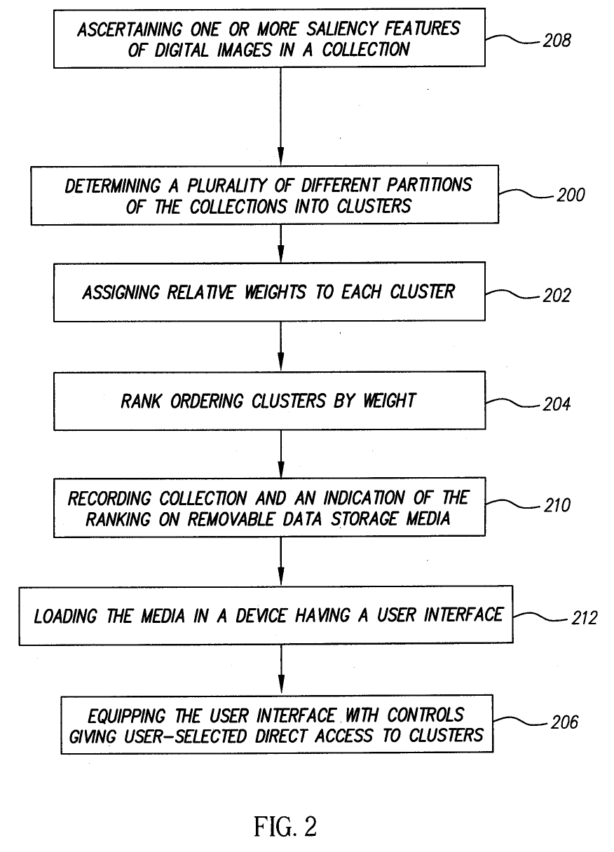

Referring to FIG. 2, the user interface does not have to be modified immediately. The ranking or a leading portion of the ranking can instead be saved (210) in memory (with or without the collection) and later used. The saved ranking can be transferred from one device to another or from one system to another as a signal or as recorded on removable data storage media and then can be loaded (212) and used. The user interface of the new device or system is then equipped (206) with the controls of the active list, giving user-selected direct access to each of the clusters of at least a leading portion of the ranking. The active list can be transferred in any form necessary to provide the appropriate changes in the user interface and can be provided as a user profile that optionally includes one or more other user preferences. For example, the active list can be transferred along with software necessary for its operation.

The active list can be transferred with the collection, or independent of the collection, on removable storage media or as digital signal. The media is loaded or the signal is received in a device and the user interface of the device is equipped with the user controls of the active list, thus, identifying and giving user-selected direct access to each of the clusters of the leading portion of ranking. The active list is transferable independent of the collection. In that case, only those image records that are available will be directly accessible using the active list. As an alternative, the active list can be transferred to a new collection. This requires ascertaining those image records in the new collection having saliency features and metadata matching the provided active listing and then making those new image records available using the active listing.

The invention has been described in detail with particular reference to certain preferred embodiments thereof, but it will be understood that variations and modifications can be effected within the spirit and scope of the invention.

1. A method for providing access to a collection of records via a user interface, the method comprising the steps of:
determining a plurality of different partitions of the collection, each said partition being based on a different parameter, each said partition dividing all of the records of the collection into two or more clusters, said records of each of said clusters having different values of the respective said parameter;
assigning weights to each of said clusters relative to all of the other clusters of all of said partitions;
rank ordering said clusters by said weights to provide a single ranking; and
equipping the user interface with controls identifying and giving user-selected direct access to each of the clusters of a leading portion of said ranking.

2. The method of claim 1 wherein said assigning limits each said partition having binary clusters to only one cluster in said leading portion of said ranking.

3. The method of claim 1 wherein said records are image records and said parameters are based on one or more of: saliency features of said image records, metadata associated with said image records, and combinations of said saliency features and said metadata, said saliency features including semantic saliency features and structural saliency features, said metadata including one or more of: capture information, usage information, and user profile information.

4. The method of claim 3 wherein said semantic saliency features include one of more of: presence or absence of people, number of people, gender of people, age of people, presence or absence of sports equipment, presence or absence of buildings, presence or absence of animals, redeye, eye blink, emotional expression, head size, translation problem, subject centrality, scenery type, presence or absence of buildings; and said structural saliency features include one or more of: image sharpness, image noise, contrast, presence or absence of dark background, scene balance, skin tone color, saturation, clipping, aliasing, and compression state.

5. The method of claim 3 wherein said capture information includes one of more of capture date/time, photographer identity, scene location, focus distance, flash used or flash not used, date metadata matching one of a predetermined set of criteria, sports/fast action mode selected or deselected; and said usage information includes one or more of: number of times printed, size of printed images, number of times viewed, and number of times emailed.

6. The method of claim 1 wherein said parameters are selected from the group consisting of: number of people, presence or absence of buildings, flash used or flash not used, presence or absence of date metadata matching one of a predetermined set of holidays, presence or absence of date metadata matching one of a predetermined set of birthdays, sky present or absent and focus at infinity, and sports/fast action mode selected or deselected.

7. The method of claim 1 wherein said equipping further comprises generating a menu listing said clusters in order of said ranking, without human intervention.

8. The method of claim 1 wherein said assigning further comprises assigning a preset weight to one or more of said clusters, said weight being low relative to other said clusters.

9. The method of claim 1 wherein said weights of said image records in said leading portion are each based on the number of the image records in the respective said cluster.

10. The method of claim 9 wherein said weights of said image records in said leading portion are each a function of the usage of the image records in the respective said cluster.

11. The method of claim 1 wherein said controls indicate the rank order and relative weights of respective said clusters.

12. The method of claim 1 further comprising recording said collection and an indication of said ranking on removable data storage media.

13. A method for providing access to a collection of image records via a user interface, the image records each including one or more digital images, the method comprising the steps of:
ascertaining one or more saliency features of the digital images;
determining a plurality of different partitions of all of the image records of the collection, each said partition being based on a different parameter, said parameters including said saliency features, each said partition having two or more clusters having different values of the respective said parameter;
assigning weights to each of said clusters relative to all of the other clusters of all of said partitions;
rank ordering said clusters by said weights to provide a single ranking; and
equipping the user interface with controls identifying and giving user-selected direct access to each of the clusters of a leading portion of said ranking.

14. The method of claim 13 wherein said saliency features include one or more semantic saliency features and one or more structural saliency features.

15. The method of claim 13 wherein said determining further comprises reading metadata of said image records and generating one or more of said parameter values of said image records from respective said metadata.

16. The method of claim 13 further comprising ascertaining usage of individual said image records in said collection, generating usage information metadata indicating said usage, and determining one or more of said partitions based on respective said parameters values inclusive of said usage information metadata.

17. The method of claim 13 wherein said weights are each a function of a respective value of a property common to all of said clusters.

18. The method of claim 17 wherein said weights of said image records in said leading portion are each a function of one or more of: the number of the image records in the respective said cluster and the usage of the respective said image records in the respective said cluster.

19. The method of claim 13 wherein said controls indicate the order of respective said clusters.

20. The method of claim 13 further comprising requesting user information and predetermining said parameters using said user information.

21. The method of claim 13 further comprising saving said ranking in a user profile, said user profile being transferable from a system having the user interface independent of said collection of image records.

22. The method of claim 13 further comprising recording said collection and an indication of said ranking on removable data storage media.

23. The method of claim 22 wherein said indication of said ranking is included in a user profile transferable independent of said collection of images.

24. A system for differentially clustering a collection of image records, the system comprising:
memory holding said image records;
a user interface having one or more input controls and one or more output units;
a control unit operatively connected to said memory and said user interface, said control unit including:
a component determining a plurality of different partitions of the collection, each said partition being based on a different parameter, each said partition having two or more clusters having different values of the respective said parameter;
a component assigning weights to each of said clusters relative to all of the other clusters of all of said partitions;
a component rank ordering said clusters by said weights to provide a single ranking; and
a component equipping one or more of said input controls of said user interface to identify and directly access the respective said clusters of a leading portion of said ranking;
wherein said assigning component assigns weights so as to exclude a plurality of predetermined clusters from said leading portion and assigns weights to remaining said clusters of all of said partitions in accordance with an interest metric.

25. A method for providing access to a collection of image records via a user interface, the image records each including one or more digital images, each digital image having a subject and a background, the method comprising the steps of:
ascertaining one or more saliency features of the digital images;
determining a plurality of different partitions of the collection, each said partition being based on a different parameter, said parameters including said saliency features, each said partition having two or more clusters having different values of the respective said parameter;
assigning relative weights to each of said clusters;
rank ordering said clusters by said weights to provide a single ranking; and
recording said collection and an indication of said ranking on a removable data storage media.

26. The method of claim 25 further comprising:
loading the media in a device having a user interface; and
equipping the user interface of the device with controls identifying and giving user-selected direct access to each of the clusters of the leading portion of said ranking.
